(19) United States
(12) Patent Application Publication
(10) Pub. No.: US 2018/0029284 A1
(43) Pub. Date: Feb. 1, 2018

(54) SYSTEM FOR PREFORMING PLASTIC SHEETS

(71) Applicant: Compagnie Plastic Omnium, Lyon (FR)

(72) Inventors: Damien BOISSON, Lyon (FR); Jerome BRIZIN, Arbent (FR); Emilien HUMMER, Villeurbanne (FR); David TRESSE, Saint Andre de Corcy (FR); Laurent NIERING, Villette D'Anthon (FR)

(73) Assignee: Compagnie Plastic Omnium, Lyon (FR)

(21) Appl. No.: 15/522,473

(22) PCT Filed: Oct. 29, 2015
(86) PCT No.: PCT/FR2015/052923

§ 371 Date: Oct. 12, 2017

(30) Foreign Application Priority Data
Oct. 31, 2014 (FR) 1460509

(51) Int. Cl. B29C 51/08; B29C 70/44; B29C 51/38; B29C 51/46; B29C 51/28; B29C 51/00

(52) U.S. Cl. CPC B29C 51/085; B29C 51/28; B29C 51/004; B29C 51/087; B29C 51/38; B29C 51/46; B29C 70/44; B29K 2883/00; B29K 2021/006

(57) ABSTRACT

A system for preforming a sheet of plastic material (MP) including a first element forming a preforming cavity, the system including a second element adapted to be positioned opposite the first element, a set of pressing means sequentially actuated and carried by the second element to apply pressure locally to the sheet of plastic material (MP), so as to press this sheet (MP) against the first element, at least one means for sequential actuation of the pressing means.

### FIELD OF THE INVENTION

This invention relates to the technical field of producing by molding parts made from plastic material, especially by compression.

In particular, the invention relates to equipment for preforming a sheet of thermosetting or thermoplastic plastic material.

### BACKGROUND OF THE INVENTION

To produce a part made from plastic material, it is known to use a molding method by hot compression under pressure in a closed mold, generally by displacing a moving element of the mold (moved by a press) relative to a fixed element of the mold, these elements typically being made of steel.

Generally, a loading plane consisting of sheets of plastic material, typically an SMC composite material, is placed in a compression mold. This acronym stands for “sheet molding compound” or “sheet molding composite”. It may be for example a sheet consisting of thermosetting resin, generally of polyester, vinylester or epoxy type, but possibly another type of thermosetting resin, which impregnates for example fibers of glass or of other reinforcement (e.g. with 20% to 30% by weight of reinforcement), often with fillers and/or a catalyst (hardener).

The press cylinder is then actuated to close the mold and transmit a molding pressure to the plastic material.

The plastic material can then flow and take the shape of the mold cavity. While flowing, the reinforcement fibers are preferably oriented according to the flow directions. Consequently, the orientation of the fibers is no longer controlled.

This results in a privileged orientation of the reinforcement fibers, which may lead to anisotropy of the part, which will therefore have different mechanical behavior depending on the directions of the forces imposed, possibly inducing robustness less than the requirement in some areas of the finished part.

To limit this phenomenon, it is known to preform the sheets of plastic material (SMC) before introducing them in the mold to mold the finished part.

Preforming consists in placing in a preforming cavity a loading plane consisting of sheets of plastic material, typically a composite material known as “SMC” and then pressing or draping the sheets of plastic material on the mold preform.

Although the intermediate shape after the preforming process is closer to that of the final part than the initial shape of the sheet, it does not correspond exactly to the final shape as molded. In particular, there is an overthickness in the thickness direction of the sheet between the preformed sheet and the molding chamber walls when the preformed sheet is arranged in the mold. The final shape of the part, which corresponds to the shape of the molding chamber, is obtained only after molding. In other words, the thickness of the preformed blank is generally greater at the gap generated (at the cavity where the part will take shape) by the two parts of the mold in the closed molding position.

The preforming means currently used are either manual (operator), mechanical (counterweight, support bar, etc.) or pneumatic (cylinders).

These preforming means do not allow the sheet of plastic material to adapt perfectly to the preform, as illustrated in FIG. 1 which shows a sheet of plastic material (MP) pressed against a preform (PF). These means cannot in fact be used to preform the entire surface of the part (FIG. 1 at the top), since some areas, indicated by arrows on FIG. 1, have complicated profiles (non-developable surfaces, significant shape variations, deep hollows opposite their openings, for example). Good preforming would correspond to the diagram on the bottom of FIG. 1.

In addition, when using a sheet of thermosetting plastic material, such as a conventional SMC sheet for molding of auto body parts, such as a tailgate, a coverage rate of only 50% of the mold by the plastic sheet is generally observed. Lastly, these preforming means are not suitable for high mass production rates. They require, depending on the case, manual operations such as positioning the sheet of plastic material, separation after vacuuming, etc.

### OBJECT AND SUMMARY OF THE INVENTION

This invention aims to remedy these disadvantages by providing a preforming device for precise, automatic, repeatable and high rate preforming of a sheet of plastic material. The equipment according to the invention allows among other things, in a method for manufacturing automotive parts by compression molding of a sheet of thermosetting plastic material such as a sheet of SMC, to achieve coverage rates greater than 70%, preferably greater than 80%, of the mold by the sheet of plastic material, using the shape obtained by preforming, thus avoiding excessive flow incompatible with structural parts in particular.

To do this, the preforming system according to the invention uses a set of pressing means, such as inflatable bladders, sequentially actuated to apply pressure locally to the sheet of plastic material.

Thus, an object of the invention relates to a system for preforming a sheet of thermosetting plastic material comprising a first element forming a preforming cavity. The system also comprises:

a second element adapted to be positioned opposite the first element;

a set of pressing means, sequentially actuated and carried by the second element to apply pressure locally to the sheet of plastic material, so as to press this sheet against the first element;

at least one control means for sequentially actuating the pressing means. Using this system, the desired shape can be completely preformed by taking advantage of the sequential actuation of the pressing means. It is therefore possible to copy automatically, and repeatably, a draping sequence which is performed manually by an operator, and therefore without being repeatable in a production run.

According to one embodiment, at least one of the pressing means is adapted to deform under the effect of an application pressure of the pressing means. It can be made of an elastomer or porous material, or it may comprise a deformation mechanism such as a spring.

According to one embodiment, at least one of the pressing means includes an elastic skin adapted to inflate under the effect of the sequential actuation means. This elastic skin can be made of silicone.

According to a preferred embodiment, at least one of the pressing means is an inflatable bladder.

According to the invention, at least one of the pressing means can be a member forming a reference press. This member preferably comprises a surface adapted to be in contact with the sheet of plastic material comprising Teflon® and/or silicone.

According to one embodiment, the system comprises a first silicone membrane to be positioned between the pressing means and said sheet of plastic material. This first silicon membrane can be advantageously preformed.

According to one embodiment, the system comprises a second elastic membrane positioned above said first element and adapted to support a sheet of plastic material. This second membrane may advantageously be made of silicone.

Lastly, the plastic material may be a thermosetting plastic material.

The invention also relates to a method for preforming a sheet of plastic material, wherein the following steps are performed:

positioning a sheet of plastic material in a system according to one of the preceding claims;

determining a sequence for actuating said pressing means; and

activating said sequential means for actuating the pressing means according to said actuation sequence.

### BRIEF DESCRIPTION OF THE DRAWINGS

The invention will be better understood on reading the accompanying figures, which are given solely by way of example and not limiting in any way, in which:

FIG. 1 illustrates the difficulty for current preforming means to drape the SMC sheet correctly on a preforming cavity.

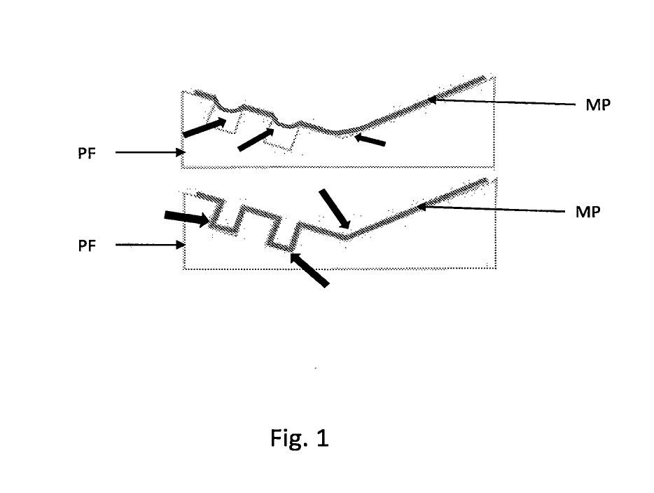

FIG. 2 is a diagram of an exemplary embodiment of the preforming system according to the invention. The upper diagram shows the system when no pressing system is actuated, and the lower diagram shows the system when all the pressing means have been actuated.

FIG. 3 illustrates the advantage of using two silicone membranes sandwiching the sheet of plastic material.

### MORE DETAILED DESCRIPTION

The system (1) according to the invention, for preforming a sheet of thermosetting plastic material (MP), for example, comprises:

a first element (2) forming a preforming cavity, and a second element (3) adapted to be positioned opposite the first element;

a set of pressing means (4), sequentially actuated and carried by the second element (3) to apply pressure locally to the sheet of plastic material (MP), so as to press this sheet (MP) against the preforming cavity (2);

at least one means (5) for sequential actuation of the pressing means (4).

The preforming cavity (2) is an element, preferably rigid, having the shapes of the part to be molded. This part can be made by machining steel, wood, foam, casting resin, etc.

The second element (3) may itself be a punch carrying the pressing means (4), i.e. it may be also rigid, and adapted to apply pressure to the sheet of thermosetting plastic material (MP). According to this embodiment, the second element (3) is adapted to close against the first element (2) in a closing direction.

But preferably, the second member (3) is not a punch. It is a light element that can be gripped by a robot. In this case, its role is to position the pressing means (4) opposite the preforming cavity (2), and to bring the pressing means (4) close to the sheet of plastic material (MP). The second element (3) and/or the robot are preferably adapted to absorb the force reactions exerted by the activated pressing means (4). According to an exemplary embodiment, the first element (2) and the second element (3) comprise means for locking the two elements (2, 3) together.

The number, size and position of the pressing means (4) are defined, according to the preforming cavity (2). Such parameters are readily determined by those skilled in the art who can, at least by trial and error or by numerical simulation, define these parameters. Similarly, the actuation sequence (order, pressure applied) of the various pressing means (4) will be determined.

The preform is a blank, consisting of one or more superimposed layers of SMC, and there may be variations of shapes, shape offsets, thickness variations for example. The finished part takes its final shape, and especially the final thicknesses, only after the molding operation. Thus, pressing means (4) are defined and used to obtain a preform, whose thickness, amongst other things, is generally greater than that of the finished part due to the stacking of layers which are only placed on top of each other and slightly pressed against each other to give them their rough shape and not yet subjected to the high pressures of the molding operation. This thickness can then be modified by compression and/or flow during the molding operation, after inserting the preform into the mold.

According to an exemplary embodiment, the pressing means (4) can be deformable under the effect of an application pressure of the pressing means (4). These means (4) may for example be made of an elastomer or porous material, or, these means (4) may comprise a deformation mechanism such as a spring, which deforms according to the variation in pressure applied by the pressing means (4) on the sheet of plastic material to be preformed. Thus, within the limit of possible deformation of the material or components of the mechanism, the pressing means (4) can take or almost take the geometry of the shape to better drape the sheet in a complex area.

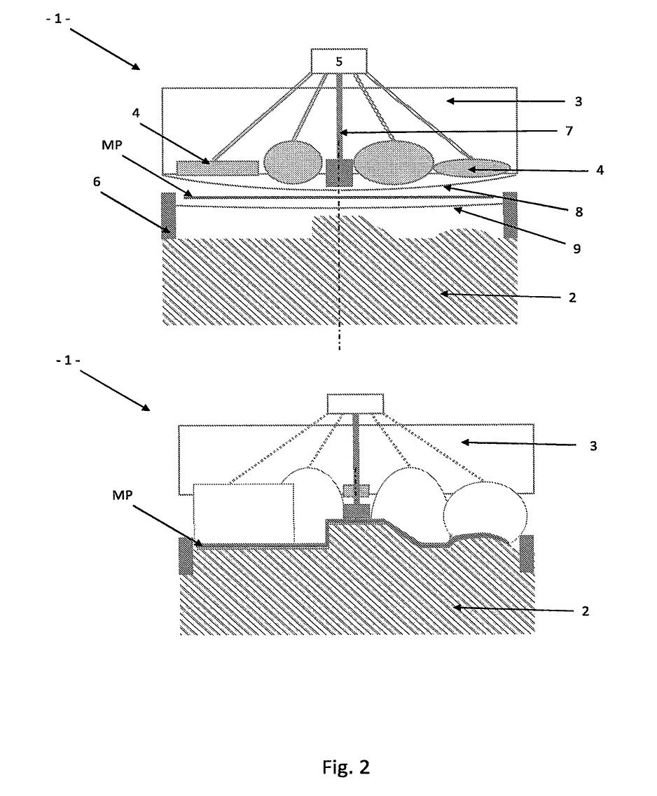

We now refer to FIG. 2 which illustrates an advantageous exemplary embodiment of the system (1) according to the invention.

According to this example, the system (1) further comprises a frame (6) carried by the preforming cavity (2), and inserted between the two elements (2, 3) to hold the sheet of plastic material (MP) above the preforming cavity (2), before actuating the pressing means (4).

Advantageously, at least one of the pressing means (4) comprises an elastic skin adapted to inflate under the effect of the sequential actuation means (5). Advantageously, the skin is made of silicone so as not to stick to the sheet of plastic material (MP). Inflation of the skin presses it against the sheet (MP), then applies a pressure on this sheet (MP). Thus, the more the skin is inflated, the greater the pressure applied to the sheet (MP), forcing the sheet to take the shapes of the cavity. This system thus allows precise control and allows the gradual and continuous application of pressure to the sheet (MP).

In addition, the elasticity of such skin gives it a deformability allowing it to take complex shapes on the preforming cavity (2) and thus giving the sheet the corresponding shape more precisely, enabling correct draping of the sheet (MP) on the preforming cavity (2).

The sequential actuation means (5) may, according to this configuration, comprise a pump connected to the pressing means (4) by components such as pipes. The pump is adapted to send a pressurized gas independently in each pipe, so as to inflate the pressing means (4) sequentially. These pressing means (4) can thus be inflated using compressed air from the industrial network (5-7 bar). The actuation sequence is controlled by a device such as a computer and valves forming an integral part of the sequential actuation means (5).

According to an exemplary embodiment having such a skin, a set of pressing means (4) constitutes an inflatable bladder assembly, as shown on FIG. 2. These bladders, supported by the second element (3), are positioned opposite the first element (2). The sheet of plastic material (MP) is positioned between the two elements (2 and 3). The bladders are positioned in specific locations, defined previously. These are positions where pressure must be applied at a given time to press and drape the sheet (MP) against the preforming cavity (2).

As illustrated on FIG. 2, the bladders may have various shapes. These shapes are preferably adapted to the shape of the preforming cavity zone (2) on which the bladders must press the sheet (MP). In particular, FIG. 2 illustrates an embodiment where the bladders have different shapes. On the diagram at the bottom of FIG. 2, unlike the top diagram, the bladders are inflated and press the sheet (MP) on the cavity (2). Rounded bladders can take complex shapes.

According to another example, but according to the same operating principle, all the bladders are replaced by a single membrane covering the surface to be preformed, and having a plurality of pockets, each pocket being hermetically separated from the others, so as to be operated independently of the others, and in particular, sequentially. It can also be two membranes welded or glued in places to form said pockets.

According to another embodiment, at least one of the pressing means (4) comprises a mechanical means such as a pad, adapted to be pressed against the sheet (MP) under the effect of the sequential actuation means (5).

Advantageously, the system includes, amongst the pressing means (4), at least one member (7) forming a reference press. A reference press means a press on the sheet of plastic material (MP) against the preforming cavity (2) preventing the sheet (MP) from moving at the position of this press, thereby fixing the position of the sheet (MP). This press thus ensures the repeatability of the operation by “blocking”, before preforming, certain areas of the part. Then, by sequential actuation of other pressing means (4), the sheet (MP) is pressed, spread, around this reference press against the preforming cavity (2). Such a press provides a pressing force greater than that produced by a bladder, so that the sheet (MP) is not pulled or does not slide from its reference position when the next sequential pressures are exerted and then pull on the sheet (MP) to position it correctly on the preforming cavity (2). There may of course be several reference presses.

Advantageously, the member (7) forming reference press includes Teflon® and/or silicone on its surface where it presses on the sheet (MP) so as not to stick to the sheet (MP).

According to one embodiment, also illustrated in FIG. 2, the system comprises a first silicone membrane (8) forming a separating layer, whose function is to prevent the bladders (4) from sticking to the sheet of plastic material (MP) if they are not formed themselves of non-stick material. Due to its properties, silicone does not stick to a sheet of thermosetting plastic material of SMC type.

This first membrane (8) can also help to keep the bladders above the preform before preforming.

Advantageously, the shape of this first silicone membrane (8) is adapted to the preforming cavity as shown on FIG. 2, thus limiting the pressure to be applied via the bladders (4) so that they can press the sheet (MP) on the preform (2).

According to one embodiment, also illustrated on FIG. 2, the system comprises a second elastic membrane (9) whose function is to keep the sheet of plastic material (MP) above the preforming cavity (2) before implementing the pressing means (4), thus favoring preforming by accompanying the displacement and sliding of the sheet on the cavity shapes.

To prevent the sheet of plastic material (MP) from sticking to the preforming cavity (2), the second membrane (9) is preferably made of silicone. This membrane (9) can be supported by the frame (6).

Lastly, this second membrane (9) can advantageously be used to eject the preformed part. The high elasticity of the membrane (9) is used to do this: on returning to its flat shape, the membrane (9) ejects the preformed part out of the preforming cavity (2).

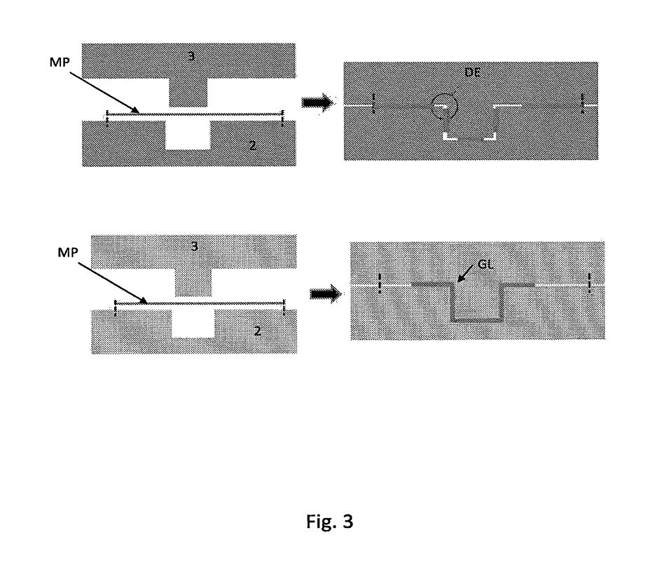

The advantage of the two silicone membranes (8 and 9) is also to allow the sheet of thermosetting plastic material (MP) to slide along the surface of the preforming cavity (2). This sliding does not necessarily mean an overall movement of the sheet (MP), since if a reference press is applied, the sheet (MP) remains locally underneath this press in a fixed position. The rest of the sheet (MP), however, not prevented from moving by the reference press, slides and deforms to be draped by pressing and sliding on the preforming cavity (2). This sliding allows the sheet (MP) to cover the preforming cavity (2) without tearing, since the sheet may adapt to the preform. FIG. 3 illustrates this advantage: the top diagrams illustrate preforming without a silicone membrane, while the bottom diagrams illustrate preforming with a silicone membrane (not shown) inserted between the sheet (MP) and the first and second elements (2, 3). Note the possible occurrence of tearing (DE) at the right angles of the preform, when there is no silicone, but a slide (GL) when silicone is present.

The invention also relates to a method for preforming a sheet of thermosetting plastic material of SMC type, using the system (1) according to the invention.

The method thus comprises the following steps:
positioning a sheet of thermosetting plastic material (MP) in a system (1) according to invention;
determining a sequence for actuating said pressing means (4); and
activating said sequential means (5) for actuating the pressing means (4) according to said actuation sequence.

The plastic sheet thus preformed now has a shape in between the original shape of the sheet, generally flat, and the final shape of the part after molding.

The actuation sequence of said pressing means (4) can be determined by performing a numerical simulation using software known to specialists and used to model the draping of a sheet of thermosetting plastic material (MP) of SMC type.

The actuation sequence of said pressing means (4) can be determined by conducting a series of trial-and-error tests, based for example on what an operator would do manually.

According to a preferred embodiment, reference presses of the system (1) are actuated first.

1. A system for preforming a sheet of plastic material (MP), the system comprising:
a first element forming a preforming cavity;
a second element opposite the first element;
a set of pressing means, configured to be sequentially actuated and carried by the second element to apply pressure locally to the sheet of plastic material (MP), for pressing the sheet of plastic material (MP) against the first element; and
at least one sequential actuation means for sequentially actuating the pressing means.

2. The system according to claim 1, wherein at least one of the pressing means is configured to deform under an application pressure of the pressing means.

3. The system according to claim 1, wherein the pressing means comprises one of:
an elastomer or porous material, and
biasing mechanism.

4. The system according to claim 1, wherein at least one of the pressing means comprises an elastic skin configured to inflate due to an effect of the sequential actuation means.

5. The system according to claim 4, wherein the elastic skin comprises silicone.

6. The system according to claim 1, wherein at least one of the pressing means is an inflatable bladder.

7. The system according to claim 1, wherein at least one of the pressing means is a member forming a reference press.

8. The system according to claim 7, wherein the member comprises a surface in contact with the sheet of plastic material (MP), the surface of the member including Teflon® and/or silicone.

9. The system according to claim 1, further comprising a first silicone membrane between the pressing means and said sheet of plastic material (MP).

10. The system according to claim 9, wherein the first silicone membrane is preformed.

11. The system according to claim 1, further comprising a second elastic membrane above said first element and configured to support the sheet of plastic material (MP).

12. The system according to claim 11, wherein the second elastic membrane comprises silicone.

13. The system according to claim 1, wherein the sheet of plastic material comprises a thermosetting plastic material.

14. A method for preforming a sheet of plastic material (MP), the method comprising:
positioning a sheet of plastic material (MP) in a system according to claim 1;
determining an actuation sequence for actuating said pressing means; and
activating said sequential actuation means for sequentially actuating the pressing means according to said actuation sequence.
